(19) United States
(12) Patent Application Publication
(10) Pub. No.: US 2026/0203397 A1
(43) Pub. Date: Jul. 16, 2026

(54) Adaptive Domain-Synergy Capsule Network (ADSCN)

(71) Applicant: Bank of America Corporation, Charlotte, NC (US)

(72) Inventor: Jason Swope, Denver, CO (US)

(21) Appl. No.: 19/016,244

(22) Filed: Jan. 10, 2025

(51) Int. Cl. G06F 21/55

(52) U.S. Cl. CPC G06F 21/554

(57) ABSTRACT

A computing platform may receive event processing requests. The computing platform may integrate, into the event processing requests, domain knowledge. The computing platform may reduce, using temporal sequence compression, the integrated event processing requests into high-signal segments. The computing platform may generate, using capsule-based representation learning, capsule structures representing the high-signal segments. The computing platform may access at least one unauthorized activity detection model. The computing platform may analyze, using the at least one unauthorized activity detection model, the event processing requests, which may include selectively retrieving, for the at least one unauthorized activity detection model and using contextual indexing, a subset of relevant capsule structures from the capsule structures. The computing platform may output, using the at least one unauthorized activity detection model, a unauthorized activity output for the event processing requests. The computing platform may initiate, based on the unauthorized activity output, one or more security actions.

### BACKGROUND

In some instances, it may be difficult to address escalating financial services sector risks. Traditional deep learning approaches, such as long-short term memory (LSTM) and transformers, may need help maintaining an optimal balance between model complexity and computational efficiency. Such models may need to incorporate domain-specific knowledge efficiently and may require extensive manual tuning of parameters (e.g., label weights). These shortcomings may make easier-to-scale models less interpretable and potentially misaligned with critical industry-specific considerations, such as varying transaction contexts or subtle unauthorized activity patterns. LSTMs, though adept at sequential data handling, may demand high computational resources and may be sensitive to hyperparameters, which may result in overfitting or suboptimal performance. While powerful and flexible, transformers may introduce complexity and high memory usage, which may hinder practical deployment in time-sensitive, large-scale unauthorized activity detection environments. Some simpler baseline methods, like rule-based systems or traditional machine learning classifiers, may incorporate domain knowledge through manual feature engineering, but might not be able to dynamically learn sequence representations. As a result, practitioners must choose between brute-forcing complex models, relying on labor-intensive feature engineering, or settling for less capable legacy detection methods.

### SUMMARY

Aspects of the disclosure provide effective, efficient, scalable, and convenient technical solutions that address and overcome the technical problems associated with the use of machine learning to detect unauthorized activity. In accordance with one or more embodiments of the disclosure, a computing platform comprising at least one processor, a communication interface, and memory storing computer-readable instructions may receive event processing requests. The computing platform may integrate, into the event processing requests, domain knowledge. The computing platform may reduce, using temporal sequence compression, the integrated event processing requests into high-signal segments. The computing platform may generate, using capsule-based representation learning, capsule structures representing the high-signal segments. The computing platform may access at least one unauthorized activity detection model. The computing platform may analyze, using the at least one unauthorized activity detection model, the event processing requests, which may include analyzing the event processing requests by selectively retrieving, for the at least one unauthorized activity detection model and using contextual indexing, a subset of relevant capsule structures from the capsule structures. The computing platform may output, using the at least one unauthorized activity detection model and based on the subset of relevant capsule structures, an unauthorized activity output for the event processing requests. The computing platform may initiate, based on the unauthorized activity output, one or more security actions.

In one or more instances, the event processing requests may include raw transaction data associated with a sequence of transactions. In one or more instances, the computing platform may maintain, using reinforcement-guided multitask coordination, feedback loops connected to one or more of the temporal sequence compression or the capsule based representation learning.

In one or more examples, the at least one unauthorized activity detection model may be one or more of: a risk model, an anomaly score generation model, or a unauthorized activity classification model. In one or more examples, the domain knowledge may be one or more of regulatory guidelines, merchant risk profiles, or evolving threat intelligence.

In one or more instances, the domain knowledge may be dynamically updated without manual curation and using an unsupervised component that surfaces previously unknown domain factors influencing unauthorized activity detection. In one or more instances, integrating the domain knowledge may include: 1) constructing a domain-specific knowledge graph based on the domain knowledge, where: a) the domain-specific knowledge graph may be a weighted adjacency matrix, b) the nodes of the domain-specific knowledge graph may correspond to domain entities, c) the domain entities may be one or more of merchant categories, known unauthorized internet protocol ranges, or transaction velocity thresholds, and d) edges in the domain-specific knowledge graph correspond to relationships between the domain entities, 2) transforming the domain entities into low-dimensional vector embeddings, and 3) aligning the low-dimensional vector embeddings with the event processing requests.

In one or more examples, generating the capsule structures representing the high-signal segments may include: 1) segmenting, based on domain-specific heuristics, the integrated event processing requests into variable length windows, 2) assessing, using a significance function comprising a lightweight convolutional layer combined with a gating mechanism, contributions of local subsequences within each of the variable length windows, where the significance function may calculate importance scores based on patterns including one or more of: abrupt spending spikes, unusual merchant transitions, or anomalous device usage, and wherein the contributions are based on the importance scores, 3) filtering, from the capsule structures, the local subsequences associated with importance scores below a predetermined threshold value, and 4) generating, using remaining subsequences of the filtered local subsequences, the capsule structures representing the high-signal segments.

In one or more instances, the computing platform may transform, using the capsule structures, the remaining subsequences into vector outputs encoding attributes indicating one or more of: transaction frequency anomalies or merchant-based irregularities. The computing platform may generate, by aggregating the encoded attributes, domain-aligned capsule archetypes, which may be predefined templates representing known industry risk profiles, and where the domain-aligned capsule archetypes guide generation of a noise-resistant capsule vector set that reflects evolving unauthorized activity patterns.

In one or more examples, the computing platform may implement a hierarchical reinforcement learning framework that refines, based on system states of the computing platform, one or more of: the temporal sequence compression or the capsule-based representation learning, where the system states may be derived from one or more of: predictive accuracy measures, computational load, or evolving unauthorized activity patterns, and where the refining may include: 1) updating, using a first layer of the hierarchical reinforcement learning framework, strategic objectives, 2) updating, using a second layer of the hierarchical reinforcement learning framework, task specific parameters including weights for one or more of: unauthorized activity classification, anomaly scoring, or merchant assessment, and performing convergence one or more of actor-critic optimization or proximal policy optimization.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for implementing an adaptive domain-synergy capsule network for unauthorized activity detection in accordance with one or more example embodiments.

FIGS. 2A-2C depict an illustrative event sequence for implementing an adaptive domain-synergy capsule network for unauthorized activity detection in accordance with one or more example embodiments.

FIG. 3 depicts an illustrative method for implementing an adaptive domain-synergy capsule network for unauthorized activity detection in accordance with one or more example embodiments.

FIG. 4 depicts an illustrative user interface for implementing an adaptive domain-synergy capsule network for unauthorized activity detection in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Adaptive domain-synergy capsule network (ADSCN) is a new deep learning architecture designed to tackle the core challenges of embedding behavioral sequence data in unauthorized activity detection in transactions. Distinct from existing long-short term memory (LSTM) or transformer-based methods, ADSCN introduces a multi-component framework that simultaneously integrates domain-specific knowledge, compresses temporal information, and autonomously adapts learning objectives. By doing so, ADSCN achieves computational efficiency, interpretability, and domain alignment that prior methods lack.

For example, ADSCN pioneers an approach that does not rely solely on sequence modeling, but holistically combines domain synergy, temporal compression, capsule-based learning, and adaptive multitask optimization. Existing architecture fails to integrate these elements into a single unified system. ADSCN may balance high interpretability, efficiency, and adaptiveness, providing a breakthrough solution for the ever-evolving landscape of unauthorized activity detection in the ecommerce sector. In essence, ADSCN is more than just a model, it is a new paradigm that intelligently marries domain knowledge and advanced machine learning techniques to elevate unauthorized activity detection to unprecedented levels of effectiveness and scalability.

These and other features are described in greater detail below.

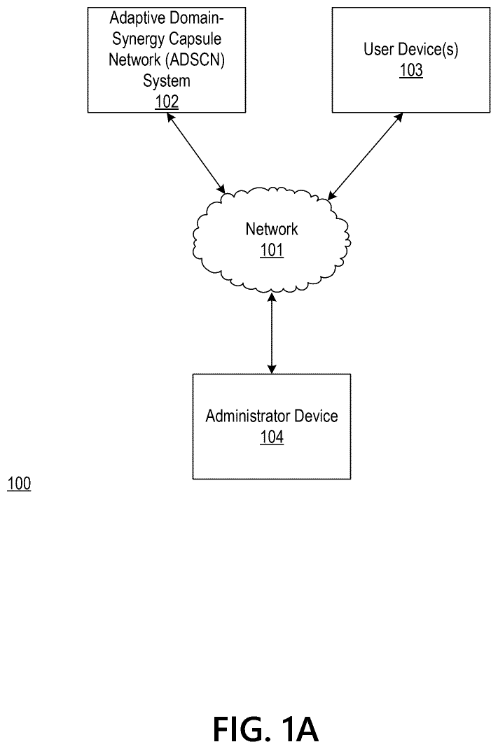

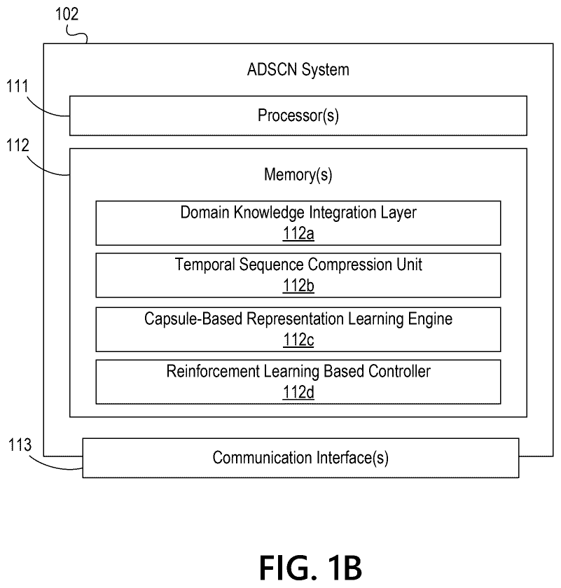

FIGS. 1A-1B depict an illustrative computing environment for implementing an adaptive domain-synergy capsule network for unauthorized activity detection in accordance with one or more example embodiments. Referring to FIG. 1A, computing environment 100 may include one or more computer systems. For example, computing environment 100 may include ADSCN system 102, user device(s) 103, and administrator device 104.

ADSCN system 102 may include one or more computing devices (servers, server blades, or the like) and/or other computer components (e.g., processors, memories, communication interfaces, or the like). For example, the ADSCN system 102 may be configured to support one or more processes to perform unauthorized activity detection, such as domain knowledge integration, temporal sequence compression, capsule-based representation learning, reinforcement guided multitask coordination, and/or other processes.

User device(s) 103 may be or include one or more devices (e.g., laptop computers, desktop computer, smartphones, tablets, and/or other devices) configured for use in providing event processing requests (e.g., requests to perform execute a transaction, or the like) for authentication and execution. For illustrative purposes in the event sequence described below, it may be assumed that any number of user devices may be included in the computing environment described herein.

Administrator device 104 may be or include one or more devices (e.g., laptop computers, desktop computer, smartphones, tablets, and/or other devices) configured for use in displaying the results of the unauthorized activity detection. For example, the administrator device 104 may display one or more graphical user interfaces configured with such results.

Computing environment 100 also may include one or more networks, which may interconnect ADSCN system 102, user device(s) 103, and administrator device 104. For example, computing environment 100 may include a network 101 (which may interconnect, e.g., ADSCN system 102, user device(s) 103, and administrator device 104).

In one or more arrangements, ADSCN system 102, user device(s) 103, and administrator device 104 may be any type of computing device capable of receiving a user interface, receiving input via the user interface, and communicating the received input to one or more other computing devices, and/or training, hosting, executing, and/or otherwise maintaining one or more artificial intelligence models. For example, ADSCN system 102, user device(s) 103, and administrator device 104 and/or other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of ADSCN system 102, user device(s) 103, and administrator device 104 may, in some instances, be special-purpose computing devices configured to perform specific functions.

Referring to FIG. 1B, ADSCN system 102 may include one or more processors 111, memory 112, and communication interface 113. A data bus may interconnect processor 111, memory 112, and communication interface 113. Communication interface 113 may be a network interface configured to support communication between ADSCN system 102 and one or more networks (e.g., network 101, or the like). Memory 112 may include one or more program modules having instructions that when executed by processor 111 cause ADSCN system 102 to perform one or more functions described herein and/or one or more databases that may store and/or otherwise maintain information which may be used by such program modules and/or processor 111. In some instances, the one or more program modules and/or databases may be stored by and/or maintained in different memory units of ADSCN system 102 and/or by different computing devices that may form and/or otherwise make up ADSCN system 102. For example, memory 112 may have, host, store, and/or include domain knowledge integration layer (DKIL) 112a, temporal sequence compression (TSC) unit 112b, capsule-based representation learning engine 112c, and reinforcement learning (RL) based controller 112d.

DKIL 112a may support embedding curated domain insights directly into model initialization. For example, ADSCN may seamlessly merge external domain knowledge, such as regulatory guidelines, merchant risk profiles, known unauthorized activity patterns, evolving threat intelligence, or the like, into the neural pipeline at initialization. Instead of relying on manual feature engineering, DKIL 112a may use a domain graph encoder that systematically transforms curated industry insights into vector embeddings. These vector embeddings may be dynamically updated and may be context-aware, ensuring that each new transaction sequence may be processed in the context of relevant domain factors.

Temporal sequence compression (TSC) unit 112b may be configured to apply a specialized compression mechanism that identifies and retains only the most discriminative segments of a behavioral sequence. Using a sliding window of variable size and a learned significance function, the TSC unit 112b may determine which segments matter most, such as sudden spikes in high-value transactions or unusual merchant shifts, which may reduce computational overhead while preserving critical unauthorized activity signals. This may offer improvements over traditional sequential models, which may process every transaction event step-by-step, often leading to information redundancy and inefficiencies.

Capsule-based representation learning engine 112c may support the use of capsule networks to encapsulate complex, hierarchical unauthorized activity behaviors. Each capsule may represent a distinct factor within the transaction sequence (e.g., normal purchasing cadence, suspicious merchant clusters, or the like). Domain embeddings from DKIL and compressed sequences from TSC may feed into the capsule routing algorithm, which may dynamically organize capsules into coherent patterns. Such an approach may produce interpretable, structured representations robust to noisy, non-stationary input data, which may be a common characteristic of evolving unauthorized behaviors.

RL based controller 112d may be configured to adjust task weights in real time, guided by performance feedback. Over time, this may cause the ADSCN system 102 to converge on an optimal weighting strategy, ensuring that each objective is addressed proportionally to its relevance without human intervention. For example, rather than manually tuning label weights or requiring fixed loss functions, the RL based controller 112d may cause the ADSCN system 102 to leverage a reinforcement learning loop to autonomously balance multiple objectives.

The above described components of the ADSCN system 102 architecture may enable scalability. For example, the TSC unit 112b may ensure the ADSCN system 102 processes fewer but more informative inputs, reducing run-time complexity. The capsule structure may eliminate the need for wide multi-layer models by focusing on quality over quantity of features. Thus, the ADSCN system 102 may scale to massive transaction datasets without the exponential memory growth common in transformer variants.

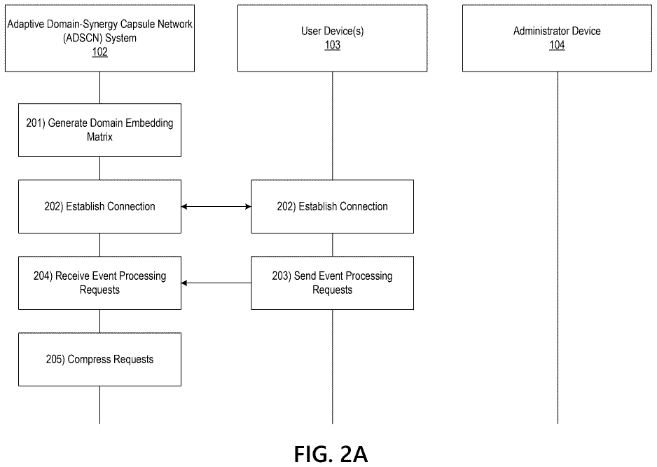

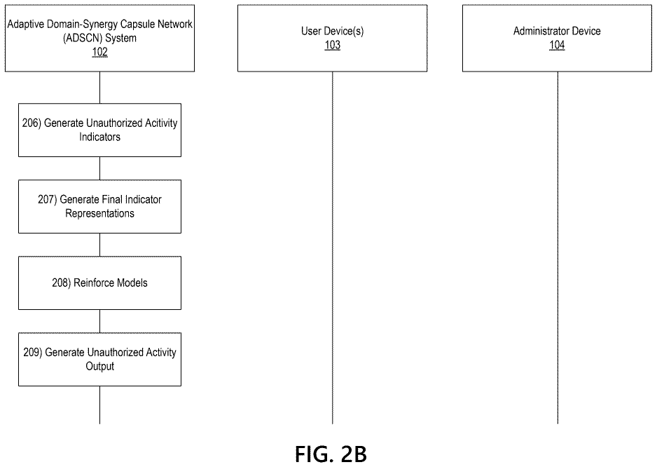

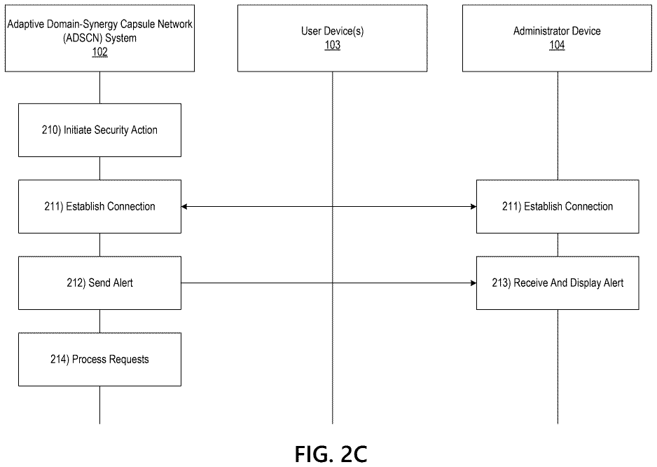

FIGS. 2A-2C depict an illustrative event sequence for implementing an adaptive domain-synergy capsule network for unauthorized activity detection in accordance with one or more example embodiments. Referring to FIG. 2A, at step 201, the ADSCN system 102 may generate a domain embedding matrix. For example, the DKIL 112a may load and encode domain insights (e.g., known risky merchant identifiers, suspicious internet protocol ranges, regulatory guidelines, merchant risk profiles, and/or other evolving threat intelligence, or the like) into the domain embedding matrix. Unlike existing feature engineering approaches, DKIL 112a may dynamically update and contextualize domain factors, thus ensuring that each transaction sequence may be interpreted through a precise, industry-specific lens without human intervention.

To do so, the DKIL 112a may use an unsupervised component that may surface previously unknown domain factors influencing fraud detection, which may augment the knowledge base without human curation. In doing so, the DKIL 112a may autonomously uncover previously unknown, latent domain-specific factors that may influence detection effectiveness, which may eliminate the need for manual curation and enable truly data-driven adaptive insights.

More specifically, the DKIL 112a may construct a domain-specific knowledge graph from curated industry regulations, merchant risk profiles, emerging threat intelligence, and/or other information. This graph may be represented as a weighted adjacency matrix, where nodes may correspond to domain entities, such as merchant categories, known unauthorized IP ranges, transaction velocity thresholds, or the like, and edges may encode relationships, relevance metrics, or the like. An embedding module may apply a graph-based representation learning algorithm (e.g., a graph convolutional network) to transform these entities into low-dimensional vector embeddings.

For example, the DKIL 112a may compute a context vector that captures sequence-specific nuances, referencing static domain vectors and temporal signals. Simultaneously, an unsupervised factor discovery component may systematically scan embedded domain knowledge to identify latent risk factors not explicitly labeled in the original graph, refining its internal representation incrementally. The final output of DKIL 112a may then be a set of domain-informed, context adaptive embeddings that may be fed directly into the capsule-based representation learning engine 112c for improved unauthorized activity detection accuracy and adaptability. This approach may ensure the integration of newly discovered domain insights.

At step 202, the user device(s) 103 may establish a connection with the ADSCN system 102. For example, the user device(s) 103 may establish a first wireless data connection with the ADSCN system 102 to link the user device(s) 103 to the ADSCN system 102 (e.g., in preparation for sending event processing requests). In some instances, the user device(s) 103 may identify whether connections are already established with the ADSCN system 102. If such connections are already established, the user device(s) 103 might not re-establish the connections. If such connections are not yet established, the user device(s) 103 may establish the first wireless data connections as described herein.

At step 203, the user device(s) 103 may send event processing requests to the ADSCN system 102. For example, the user device(s) 103 may send requests to execute transactions and/or perform other processing, which may, e.g., be represented as a time-series of transaction information. In some instances, the user device(s) 103 may send the event processing requests to the ADSCN system 102 while the first wireless data connection is established.

At step 204, the ADSCN system 102 may receive the event processing requests sent at step 203. For example, the ADSCN system 102 may receive the event processing requests via the communication interface 113 and while the first wireless data connection is established. In some instances, these requests may correspond to an incoming transaction sequence.

At step 205, the ADSCN system 102 may feed the event processing requests into the TSC unit 112b to compress the event processing requests. For example, the TSC unit 112b may execute an innovative compression strategy that identifies and isolates the most discriminative segments of transaction sequences in real-time. Unlike traditional step by step processing, which may yield redundancy and inefficiency, the TSC unit 112b may filter out low-impact data points, which may drastically reduce computational overhead while amplifying the signal of critical unauthorized activity indicators.

In some instances, the TSC unit 112b may utilize cross-sequence pattern alignment. For example, a comparative module may identify similarities or divergences between concurrent transaction sequences, and may leverage these comparisons to highlight critical subsequences that generalize well to broader unauthorized activity detection context. This may uniquely leverage concurrent transactional streams to highlight and extract critical subsequences that generalize across multiple unauthorized activity contexts, which may offer a novel comparative dimension absent in standard temporal compression approaches.

More specifically, to perform such compression of the event processing requests, the TSC unit 112b may segment the incoming transactional time series (corresponding to the requests) into variable length windows informed by domain-specific heuristics encoded as learned parameters. Within each window, a significance function, typically implemented as a lightweight convolutional layer combined with a gating mechanism, may quantitatively assess the contribution of local subsequences to the overall unauthorized activity detection objective. This function may calculate importance scores based on patterns such as abrupt spending spikes, unusual merchant transitions, anomalous device usage, or the like. Concurrently, the above described cross-sequence pattern alignment subroutine may compare these localized features against analogous subsequences extracted from parallel transaction streams, thereby identifying consistent unauthorized activity-related signatures. Once high-value segments are identified, the TSC unit 112b may filter out low-signal intervals, preserving only those subsequences that consistently exhibit high discriminative potency. The retained subsequences may then be seamlessly integrated into the capsule-based representation layer, allowing the downstream routing algorithms to focus on robust, noise-resistant unauthorized activity indicators. By using dynamic windowing, automatic importance assessment, and cross-sequence alignment, the TSC unit 112b may reduce computational overhead, enhance interpretability, and maximize the ADSCN system 102's efficiency without sacrificing predictive accuracy. This may also be true during real-time operations.

Referring to FIG. 2B, at step 206, the ADSCN system 102 may feed the compressed events (e.g., generated at step 205) and the embeddings (e.g., produced at step 201), into the capsule-based representation learning (CBRL) engine 112c. For example, a distinctive utilization of capsule networks may be used to represent nested, complex unauthorized activity behaviors as structured, interpretable entities. This approach may surpass linear and attention-based models by encapsulating multifaceted transaction patterns into cohesive capsules, which may produce robust representations that may resist noise and evolving threat patterns.

To do so, domain-aligned capsule archetypes may be used. These archetypes may be predefined capsule templates that reflect domain-specific factors (e.g., known high-risk merchants, suspicious IP clusters, or the like), which ensure that learned representations remain grounded in real-world conditions and established threat profiles. They may seamlessly integrate predefined, domain-specific capsule templates into the ADSCN system's representational structure, thus ensuring that learned behaviors align with real-world threat profiles and industry conditions.

More specifically, the CBRL engine 112c may be a specialized capsule-based representation learning layer to encode hierarchical unauthorized activity behaviors into structured, interpretable capsule vectors. Unlike standard feed-forward or attention-based models, each capsule in this architecture may encapsulate a distinct behavioral feature, combining temporal compression outputs with domain specific embeddings. For example, the ADSCN system 102 may feed the preprocessed sequence segments (described above at step 205) and domain-specific embeddings (generated at step 201) into a set of primary capsules, each representing low-level behavioral patterns. These primary capsules may transform their inputs into vector outputs that may encode attributes such as transaction frequency anomalies or merchant based irregularities.

At step 207, the CBRL engine 112c may use an iterative dynamic routing procedure to refine the connection strengths between primary capsules and higher-level capsule layers, aggregating only the most relevant hierarchical patterns. The domain-aligned capsule archetypes described above may be integrated during routing, which may guide the structure of the learned embeddings. This may enable higher-level capsules to form coherent, semantically interpretable groups of behaviors. The result may be a stable, noise-resistant capsule vector set (e.g., comprising a set of final representations of the unauthorized activity indicators generated at step 206) that may reflect evolving unauthorized activity patterns suitable for downstream multitask decision-making. This approach may facilitate robust generalization across diverse financial ecosystems.

At step 208, reinforcement guided multitask coordination may dictate how the noise-resistant capsule vectors fulfill various detection tasks. For example, a breakthrough method of dynamically adjusting multiple detection goals, such as unauthorized activity classification, anomaly scoring, and merchant assessment, or the like, may be performed using a reinforcement learning loop that may fine-tune task priorities without manual weight tuning. For example, the reinforcement learning based controller 112d may enable continuous alignment with operational needs, ensuring superior adaptability as unauthorized activity typologies shift.

The reinforcement learning based controller 112d may be a layered reinforcement learning structure that manages high-level objectives (e.g., strategic unauthorized activity prevention goals, or the like) at one tier and more granular tasks (e.g., refining thresholding rules, or the like) at another, which may enable nuanced, scalable, and context sensitive control across both high-level strategic goals and granular operational tasks. This may be a capability distinctly beyond standard single layer reinforcement learning approaches.

More specifically, the reinforcement learning based controller 112d may autonomously calibrate multiple detection objectives by using a hierarchical reinforcement learning framework that operates across two optimization tiers. At the high level, a strategic controller defines overarching priorities (e.g., favoring timely anomaly detection during peak periods), while at the lower level, a secondary RL agent fine tunes task specific parameters (e.g., weights for unauthorized activity classification, anomaly scoring, merchant assessment, or the like). Each RL agent may observe system states derived from predictive accuracy measures, computational load, evolving unauthorized activity patterns, or the like. Actions may involve adjusting task weights, thresholding parameters, or sampling strategies guided by a reward signal, which may capture performing trade-offs. The top level agent may periodically update strategic objectives by evaluating long term rewards, which may ensure alignment with evolving risk landscapes. Meanwhile, the bottom level agent may execute fine-grained adjustments, refining the model's internal representation and output layer configurations. Both levels may use policy optimization methods, such as actor-critic or proximal policy optimization, which may ensure stable convergence. By dynamically adapting weights and adjusting thresholds, the reinforcement learning based controller 112d may achieve a fine-grained, context-aware balance among multiple detection tasks. This hierarchical approach may enhance resilience and scalability.

At step 209, the ADSCN system 102 may input the event processing requests into one or more of: a unauthorized activity classification model, anomaly scoring model, merchant risk model, and/or other model). The ADSCN system 102 may apply contextual indexing to selectively retrieve domain embeddings, capsule templates, multitask parameters, or the like relevant to the event processing requests. For example, doing so may result in provision of only the most relevant information for each task, which may ensure precision and computational efficiency, and may minimize unnecessary computation. This indexing may rely on a dynamically updated content-addressable memory structure, which may ensure that the ADSCN system 102 selectively activates model subsets aligned with the current inference demands. As a result, computational overhead may be reduced, and real-time, large-scale unauthorized activity detection may be performed without sacrificing interpretability, accuracy or adaptive domain relevance.

The ADSCN system 102 may then use the unauthorized activity classification model, anomaly scoring model, merchant risk model, and/or other models to produce a unauthorized activity output, indicative of a binary determination of unauthorized activity/no unauthorized activity, a score indicating a likelihood of unauthorized activity, a score indicating merchant risk, and/or other information indicative of whether the event processing requests may be associated with unauthorized activity behavior.

If unauthorized behavior is detected, the ADSCN system 102 may proceed to step 210. Otherwise, the ADSCN system 102 may proceed to step 214.

Referring to FIG. 2C, at step 210, the ADSCN system 102 may initiate one or more security actions. For example, the ADSCN system 102 may deny processing of a request, isolate a request, monitor a source of the request, and/or perform other security actions.

At step 211, the ADSCN system 102 may establish a connection with the administrator device 104. For example, the ADSCN system 102 may establish a second wireless data connection with the administrator device 104 to link the ADSCN system 102 with the administrator device 104 (e.g., in preparation for sending alerts). In some instances, the ADSCN system 102 may identify whether a connection is already established with the administrator device 104. If a connection is already established with the administrator device 104, the ADSCN system 102 might not re-establish the connection. Otherwise, if a connection is not yet established with the administrator device 104, the ADSCN system 102 may establish the second wireless data connection as described herein.

At step 212, the ADSCN system 102 may generate an alert indicating the detected unauthorized behavior, and may send the alert to the administrator device 104. For example, the ADSCN system 102 may send the alert to the administrator device 104 via the communication interface 113 and while the second wireless data connection is established. In some instances, the ADSCN system 102 may also send one or more commands directing the administrator device 104 to display the alert.

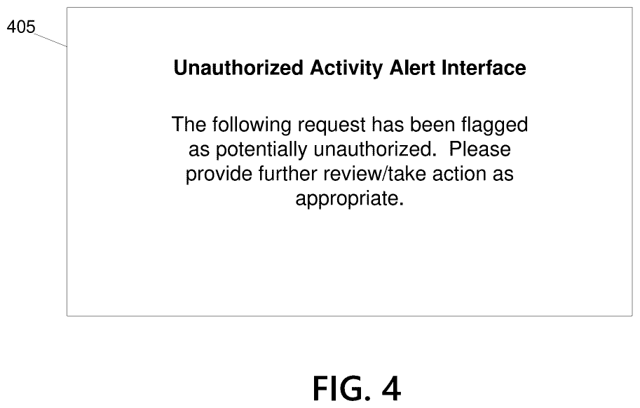

At step 213, the administrator device 104 may receive the alert sent at step 212. For example, the administrator device 104 may receive the alert while the second wireless data connection is established. In one or more instances, the administrator device 104 may also receive the one or more commands directing the administrator device 104 to display the alert. Based on or in response to these commands, the administrator device 104 may display the alert. For example, the administrator device 104 may display a graphical user interface similar to graphical user interface 405, which is illustrated in FIG. 4, and which may, e.g., notify a system administrator about the detected behavior.

Returning to step 209, if no unauthorized behavior was detected, the ADSCN system may have proceeded to step 214. At step 214, the ADSCN system 102 may process the requested events (e.g., process the requested transactions, or the like). For example, the ADSCN system 102 may execute or otherwise cause a transfer of funds, or the like.

As a result, the ADSCN system 102 described herein provides a novel system design that preserves interpretability, accuracy, and domain relevance while scaling to massive transaction volumes. By integrating TSC for data reduction and capsule networks for quality-focused representation, the ADSCN system 102 avoids the exponential resource demands typical of transformers and LSTMs, supporting real-time decision making in large, time sensitive environments.

An indexing system may retrieve only relevant model subsets (e.g., domain embeddings, capsule templates, or the like) needed for a given task or transaction cohort, which may minimize unnecessary computation. This may introduce a novel selective retrieval mechanism, which may dynamically serve only the most relevant model subsets for each task, which may ensure precision and computational efficiency unmatched by conventional end-to-end inference approaches.

The complexity-efficient architecture of the ADSCN system 102 may integrate temporal sequence compression, capsule-based representation, and contextual indexing to achieve scalable, domain-aligned inference. First, the TSC unit 112b may identify and retain only the most discriminative transaction segments, applying a sliding window mechanism with an embedded significance function. This may ensure that data fed into subsequent layers is minimized and signal-rich, curtailing unnecessary computation. Subsequently, CBRL engine 112c may translate the compressed input into hierarchical, structured representations, where each capsule may encode distinct behavioral factors. The CBRL engine 112c may use a routing algorithm to align the capsules according to meaningful interdependencies, which may bypass the need for deep, resource-intensive neural stacks. To maintain robustness and accuracy in large-scale settings, and indexing system or component of the ADSCN system 102 may retrieve only the relevant domain embeddings, capsule templates, and multitask parameters needed for a particular transaction or cohort. This indexing may rely on a dynamically updated content-addressable memory structure, which may ensure that the network selectively activates model subsets aligned with current inference demands. These integrated components may drastically reduce computational overhead, and enable real-time, large-scale unauthorized activity detection without sacrificing interpretability, accuracy, or adaptive domain relevance.

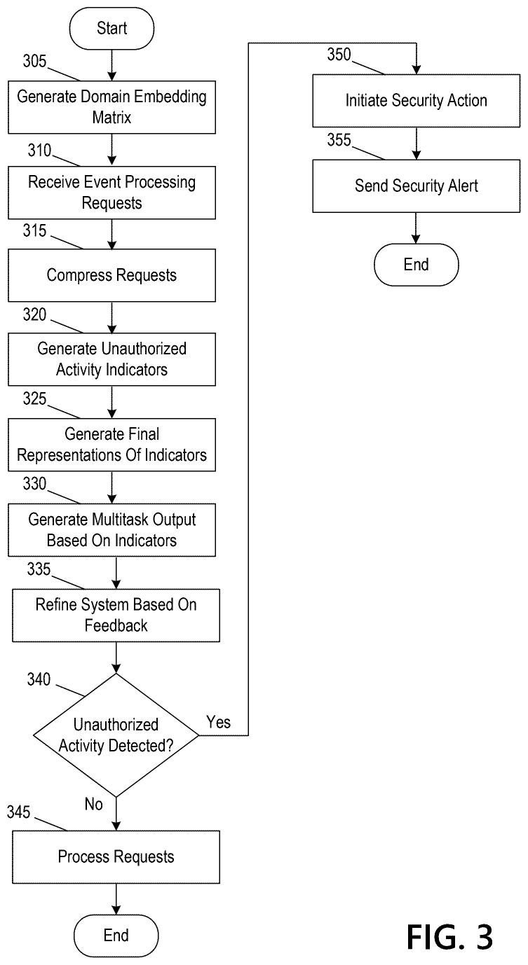

FIG. 3 depicts an illustrative method for implementing an adaptive domain-synergy capsule network for unauthorized activity detection in accordance with one or more example embodiments. Referring to FIG. 3, at step 305, a computing platform comprising one or more processors, memory, and a communication interface may generate a domain embedding matrix. At step 310, the computing platform may receive event processing requests. At step 315, the computing platform may compress the event processing requests. At step 320, the computing platform may generate unauthorized activity indicators. At step 325, the computing platform may generate final representations of the indicators. At step 330, the computing platform may generate a multitask output based on the indicators. At step 335, the computing platform may use feedback and the indicators to reinforce learning of any deployed models. At step 340, the computing platform may identify whether any unauthorized activity was detected associated with the event processing requests. If not, the computing platform may proceed to step 345 to process the requests. Otherwise, if unauthorized activity is detected, the computing platform may proceed to step 350. At step 350, the computing platform may initiate one or more security actions. At step 355, the computing platform may send a security alert to an administrator device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive event processing requests;
integrate, into the event processing requests, domain knowledge;
reduce, using temporal sequence compression, the integrated event processing requests into high-signal segments;
generate, using capsule-based representation learning, capsule structures representing the high-signal segments;
access at least one unauthorized activity detection model;
analyze, using the at least one unauthorized activity detection model, the event processing requests, wherein analyzing the event processing requests comprises selectively retrieving, for the at least one unauthorized activity detection model and using contextual indexing, a subset of relevant capsule structures from the capsule structures;
output, using the at least one unauthorized activity detection model and based on the subset of relevant capsule structures, a unauthorized activity output for the event processing requests; and
initiate, based on the unauthorized activity output, one or more security actions.

2. The computing platform of claim 1, wherein the event processing requests comprise raw transaction data associated with a sequence of transactions.

3. The computing platform of claim 1, wherein the memory stores additional computer-readable instructions that, when executed by the at least one processor, cause the computing platform to:
maintain, using reinforcement-guided multitask coordination, feedback loops connected to one or more of the temporal sequence compression or the capsule based representation learning.

4. The computing platform of claim 1, wherein the at least one unauthorized activity detection model comprises one or more of: a risk assessment model, an anomaly score generation model, or a unauthorized activity classification model.

5. The computing platform of claim 1, wherein the domain knowledge comprises one or more of regulatory guidelines, merchant risk profiles, or evolving threat intelligence.

6. The computing platform of claim 1, wherein the domain knowledge is dynamically updated without manual curation and using an unsupervised component that surfaces previously unknown domain factors influencing unauthorized activity detection.

7. The computing platform of claim 1, wherein integrating the domain knowledge comprises:
constructing a domain-specific knowledge graph based on the domain knowledge, and wherein:
the domain-specific knowledge graph comprises a weighted adjacency matrix,
nodes of the domain-specific knowledge graph correspond to domain entities, wherein the domain entities comprise one or more of merchant categories, known unauthorized internet protocol ranges, or transaction velocity thresholds, and
edges in the domain-specific knowledge graph correspond to relationships between the domain entities;
transforming the domain entities into low-dimensional vector embeddings; and
aligning the low-dimensional vector embeddings with the event processing requests.

8. The computing platform of claim 1, wherein generating the capsule structures representing the high-signal segments comprises:
segmenting, based on domain-specific heuristics, the integrated event processing requests into variable length windows;
assessing, using a significance function comprising a lightweight convolutional layer combined with a gating mechanism, contributions of local subsequences within each of the variable length windows, wherein the significance function calculates importance scores based on patterns including one or more of: abrupt spending spikes, unusual merchant transitions, or anomalous device usage, and wherein the contributions are based on the importance scores;
filtering, from the capsule structures, the local subsequences associated with importance scores below a predetermined threshold value; and
generating, using remaining subsequences of the filtered local subsequences, the capsule structures representing the high-signal segments.

9. The computing platform of claim 8, wherein the memory stores additional computer-readable instructions that, when executed by the at least one processor, cause the computing platform to:
transform, using the capsule structures, the remaining subsequences into vector outputs encoding attributes indicating one or more of: transaction frequency anomalies or merchant-based irregularities; and
generate, by aggregating the encoded attributes, domain-aligned capsule archetypes comprising predefined templates representing known industry risk profiles, wherein domain-aligned capsule archetypes guide generation of a noise-resistant capsule vector set that reflects evolving unauthorized activity patterns.

10. The computing platform of claim 1, wherein the memory stores additional computer-readable instructions that, when executed by the at least one processor, cause the computing platform to:
implement a hierarchical reinforcement learning framework that refines, based on system states of the computing platform, one or more of: the temporal sequence compression or the capsule-based representation learning, wherein the system states are derived from one or more of:
predictive accuracy measures, computational load, or evolving unauthorized activity patterns, and wherein the refining comprises:
updating, using a first layer of the hierarchical reinforcement learning framework, strategic objectives,
updating, using a second layer of the hierarchical reinforcement learning framework, task specific parameters including weights for one or more of: unauthorized activity classification, anomaly scoring, or merchant assessment, and
performing convergence one or more of actor-critic optimization or proximal policy optimization.

11. A method comprising:
at a computing platform comprising at least one processor, a communication interface, and memory:
receiving event processing requests;
integrating, into the event processing requests, domain knowledge;
reducing, using temporal sequence compression, the integrated event processing requests into high-signal segments;
generating, using capsule-based representation learning, capsule structures representing the high-signal segments;
accessing at least one unauthorized activity detection model;
analyzing, using the at least one unauthorized activity detection model, the event processing requests, wherein analyzing the event processing requests comprises selectively retrieving, for the at least one unauthorized activity detection model and using contextual indexing, a subset of relevant capsule structures from the capsule structures;
outputting, using the at least one unauthorized activity detection model and based on the subset of relevant capsule structures, a unauthorized activity output for the event processing requests; and
initiating, based on the unauthorized activity output, one or more security actions.

12. The method of claim 11, wherein the event processing requests comprises raw transaction data associated with a sequence of transactions.

13. The method of claim 11, further comprising:
maintaining, using reinforcement-guided multitask coordination, feedback loops connected to one or more of the temporal sequence compression or the capsule based representation learning.

14. The method of claim 11, wherein the at least one unauthorized activity detection model comprises one or more of: a risk assessment model, an anomaly score generation model, or a unauthorized activity classification model.

15. The method of claim 11, wherein the domain knowledge comprises one or more of regulatory guidelines, merchant risk profiles, or evolving threat intelligence.

16. The method of claim 11, wherein the domain knowledge is dynamically updated without manual curation and using an unsupervised component that surfaces previously unknown domain factors influencing unauthorized activity detection.

17. The method of claim 11, wherein integrating the domain knowledge comprises:
constructing a domain-specific knowledge graph based on the domain knowledge, and wherein:
the domain-specific knowledge graph comprises a weighted adjacency matrix,
nodes of the domain-specific knowledge graph correspond to domain entities, wherein the domain entities comprise one or more of merchant categories, known unauthorized internet protocol ranges, or transaction velocity thresholds, and
edges in the domain-specific knowledge graph correspond to relationships between the domain entities;
transforming the domain entities into low-dimensional vector embeddings; and
aligning the low-dimensional vector embeddings with the event processing requests.

18. The method of claim 11, wherein generating the capsule structures representing the high-signal segments comprises:
segmenting, based on domain-specific heuristics, the integrated event processing requests into variable length windows;
assessing, using a significance function comprising a lightweight convolutional layer combined with a gating mechanism, contributions of local subsequences within each of the variable length windows, wherein the significance function calculates importance scores based on patterns including one or more of: abrupt spending spikes, unusual merchant transitions, or anomalous device usage, and wherein the contributions are based on the importance scores;
filtering, from the capsule structures, the local subsequences associated with importance scores below a predetermined threshold value; and
generating, using remaining subsequences of the filtered local subsequences, the capsule structures representing the high-signal segments.

19. The method of claim 18, further comprising:
transforming, using the capsule structures, the remaining subsequences into vector outputs encoding attributes indicating one or more of: transaction frequency anomalies or merchant-based irregularities; and
generating, by aggregating the encoded attributes, domain-aligned capsule archetypes comprising predefined templates representing known industry risk profiles, wherein domain-aligned capsule archetypes guide generation of a noise-resistant capsule vector set that reflects evolving unauthorized activity patterns.

20. One or more non-transitory computer-readable media storing instructions that, when executed by a computing platform comprising at least one processor, a communication interface, and memory, cause the computing platform to:
receive event processing requests;
integrate, into the event processing requests, domain knowledge;
reduce, using temporal sequence compression, the integrated event processing requests into high-signal segments;
generate, using capsule-based representation learning, capsule structures representing the high-signal segments;
access at least one unauthorized activity detection model;
analyze, using the at least one unauthorized activity detection model, the event processing requests, wherein analyzing the event processing requests comprises selectively retrieving, for the at least one unauthorized activity detection model and using contextual indexing, a subset of relevant capsule structures from the capsule structures;
output, using the at least one unauthorized activity detection model and based on the subset of relevant capsule structures, a unauthorized activity output for the event processing requests; and
initiate, based on the unauthorized activity output, one or more security actions.
